(19) United States
(12) Patent Application Publication
(10) Pub. No.: US 2013/0303413 A1
(43) Pub. Date: Nov. 14, 2013

(54) WEAR RESISTANT ARTICLE

(71) Applicants: J. David Booze, Wilmington, DE (US); Clifford K. Deakyne, Wilmington, DE (US); Frederic Pailler, Forest (BE); James E. Weishampel, Amherst, OH (US)

(72) Inventors: J. David Booze, Wilmington, DE (US); Clifford K. Deakyne, Wilmington, DE (US); Frederic Pailler, Forest (BE); James E. Weishampel, Amherst, OH (US)

(73) Assignee: E. I. DU PONT DE NEMOURS AND COMPANY, Wilmington (DE)

(21) Appl. No.: 13/469,181

(22) Filed: May 11, 2012

(51) Int. Cl. F16C 33/04

(52) U.S. Cl. 508/100

(57) ABSTRACT

The disclosure generally relates to wear resistant articles such as a turbine fan blade, a rotor disk, etc. having a composited lubricated sheet adhered thereon and having improved tribological properties at high temperatures.

### FIELD OF THE INVENTION

The disclosure generally relates to wear resistant articles; more particularly to wear resistant articles having adhered thereon a composite lubricating sheet.

### BACKGROUND OF THE INVENTION

Typically, wear resistant articles are used to prevent or to reduce friction and wear when in sustained contact with other objects due to relative motion of both under high load and/or frictional forces.

### SUMMARY OF THE INVENTION

A first aspect of the present invention relates to a wear resistant article comprising: a composite lubricating sheet adhered to a metal substrate, wherein the composite lubricating sheet comprises: a fabric at least partially embedded with a resin, the fabric including an aromatic polyamide yarn, and a mixed yarn having the aromatic polyamide yarn and a low-friction yarn; and a metallic layer adhered to one side of the fabric.

A second aspect of the present invention relates to a turbine engine including at least one part having a composite lubricating sheet adhered thereon, wherein the composite lubricating sheet comprises: a fabric at least partially embedded by a resin, the fabric including an aromatic polyamide yarn and a mixed yarn having the aromatic polyamide yarn and a low-friction yarn; and a metallic layer adhered to one side of the resin embedded fabric.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts an embodiment of a wear resistant article, in accordance with the present disclosure.

FIG. 2 depicts another embodiment of a wear resistant article wherein the article is depicted having a turbine fan blade 52 and a composite lubricating sheet (CLS) 8 adhered thereon.

FIG. 3 depicts another embodiment of a wear resistant article wherein the article is depicted having a rotor disk 102 and CLS 8 adhered thereon.

It is noted that the drawings of the invention are not to scale. The drawings are intended to depict only typical aspects of the invention, and therefore should not be considered as limiting the scope of the invention. In the drawings, like numbering represents like elements between drawings.

### DETAILED DESCRIPTION OF THE INVENTION

Articles used in the aerospace industry, and in particular, in turbine engines are often subjected to high pressure loads and high frictional forces between the articles and other objects in contact with the articles resulting in surface wear and crack formation due to fatigue stress of the articles and/or objects in turbine engines. Improvements in the wear resistance of articles is sought so as to improve the lifespan of the articles and/or objects in contact with articles; to reduce the maintenance time of turbine engines; and to increase the operational time of a device, assembly, airplane, etc. that incorporate such articles. Wear means the deterioration of any properties of a solid surface by the action of another surface. The deteriorated properties may include, but are not limited to, thickness, smoothness, hardness, strength, and/or integrity. It has been discovered that the wear resistance of an article may be improved or increased by having a composite lubricating sheet adhered thereon where the composite lubricating sheet has a metallic layer.

An embodiment of a wear resistant article is shown in FIG. 1, in accordance with the present disclosure. Referring to FIG. 1, a wear resistant article 2 is shown having a metal substrate 4 and a composite lubricating sheet (CLS) 8 adhered thereon. Reference 5 connotes that metal substrate 4 may continue beyond reference 5 to form a larger, complete metal substrate. Metal substrate 4 may be an integrated component in a turbine engine. In an embodiment, metal substrate 4 may be a part selected from, but not limited to, mechanical parts or components thereof that are subject to wear, such as a turbine fan blade, a rotor disk, and a rotor disk assembly. In another embodiment, metal substrate 4 may be a turbine fan blade. In another embodiment, metal substrate 4 may be a rotor disk. Metal substrate 4 may comprise a metal selected from titanium, aluminum, steel, nickel, and alloys of the aforementioned. In an embodiment, metal substrate 4 may comprise titanium. In another embodiment, metal substrate 4 may comprise steel. In another embodiment, metal substrate 4 may comprise aluminum.

CLS 8 may comprise a fabric 6 and a metallic layer 7 adhered to one side of fabric 6. Fabric 6 may be at least partially embedded with a resin, and may include an aromatic polyamide yarn and a mixed yarn having the aromatic polyamide yarn and a low-friction yarn. The aromatic polyamide yarn may be a plurality of fibers in a bundle, including fiber comprising an aromatic polyamide, used for weaving. The aromatic polyamide yarn may include yarns made from but not limited to poly(para-phenylene terephthalamide), poly(meta-phenylene terephthalamide), poly(meta-phenylene isophthalamide), poly(para-phenylene isophthalamide), combinations thereof, and copolymers thereof.

The low-friction yarn may be a yarn having a coefficient of friction (COF) against itself which is lower than the COF of the aromatic polyamide yarn against itself. The low-friction yarn may comprise graphite or a fluoropolymer. In an embodiment, the low-friction yarn may comprise graphite fiber or a fluoropolymer fiber. In an embodiment, the fluoropolymer fiber may be polytetrafluoroethylene fiber. Resin embedded fabric 6 may be at least partially embedded with a resin selected from, but not limited to, a phenolic resin, epoxy resin, or a polyimide resin. In an embodiment, the phenolic resin may comprise phenol-formaldehyde.

Metallic layer 7 may comprise a metal selected from titanium, aluminum, steel, and nickel. In an embodiment, metallic layer 7 may be titanium. In another embodiment, metallic layer 7 may be steel. Metallic layer 7 may have a thickness in a range from approximately 20 microns to approximately 1,000 microns. In an embodiment, metallic layer 7 may have a thickness in a range from approximately 50 microns to approximately 250 microns. In another embodiment, metallic layer 7 may have a thickness in a range from approximately 70 microns to approximately 100 microns. In another embodiment, metallic layer 7 may have a thickness of approximately 90 microns.

Metallic layer 7 may be in the form a metallic foil. In an embodiment, the metallic foil may be a thin, flexible sheet of titanium, aluminum, steel, or nickel. In an embodiment, metallic layer 7 may be a titanium foil. In another embodiment, the metallic foil may have a thickness in a range from approximately 20 microns to approximately 1,000 microns. In another embodiment, the metallic foil may have a thickness in a range from approximately 50 microns to approximately 250 microns. In another embodiment, the metallic foil may have a thickness in a range from approximately 70 microns to approximately 100 microns. In another embodiment, the metallic foil may have a thickness of approximately 90 microns. Metallic layer 7 may be adhered to one side of resin embedded fabric 6.

In an embodiment, metallic layer 7 may be a pure metal comprising a single metallic element. In another embodiment, metallic layer 7 may be a metal alloy comprising two or more metallic elements. When two or more metallic elements are a part of metallic layer 7, any element may be a major or predominant element by weight percent. Embodiments of elements present in metallic layer 7 include, but are not limited, to titanium, iron, aluminum, copper, nickel, zinc, tungsten, molybdenum, tin, and cobalt. Any of the aforementioned elements may be the major or predominant element by weight percent.

Metallic layer 7 may have a Vickers hardness value HV of approximately 30 or greater at a load of 100 g applied for 20 seconds according to ASTM E-384. In an embodiment, metallic layer 7 may have a Vickers HV of approximately 100 or greater. In another embodiment, metallic layer 7 may have a Vickers HV of approximately 200 or greater. In another embodiment, metallic layer 7 may have a Vickers HV of approximately 300 or greater.

An example of composite lubricating sheet 8 having a titanium metallic layer 7 is Vespel® ASB-0670 product grade available from E.I. du Pont de Nemours and Company. Other Vespel® composite lubricating sheet 8 product grades may include metallic layer 7 being steel, aluminum, or nickel.

Composite lubricating sheet (CLS) 8 may have a thickness in a range from 30 microns to 3 mm. In embodiment, CLS 8 may have a thickness in a range from 50 microns to 1 mm. In another embodiment, the thickness may be in a range from 100 microns to 750 microns.

CLS 8 may have a Compression Fraction value in a range from 0.1% (0.001) to approximately 20% (0.20) with a pressure applied by compressing at approximately 127 microns/minute up to approximately 450 MPa and then released. Compression Fraction means the fraction of thickness lost due to compression under specific conditions. In an embodiment, composite lubricating sheet 8 may have a Compression Fraction value in a range from 1% (0.010) to approximately 5.7% (0.057). In another embodiment, the Compression Fraction value may be in a range from 1.3% (0.013) to approximately 3% (0.030). The aforementioned Compression Fraction value embodiments may be determined with a pressure applied by compressing at approximately 127 microns/minute up to approximately 450 MPa and then released.

CLS 8 may be adhered to metal substrate 4 to form wear resistant article 2. The adherence of CLS 8 may be achieved through physical or chemical bonding. One may also use an adhesive such as thermoplastic adhesive, a thermoset adhesive, and other bonding adhesives known in the art. In particular, metallic layer 7 may be adhered to metal substrate 4. In an embodiment, the thermoset adhesive may be an epoxy adhesive. The bonding adhesive layer may have a thickness in range from approximately 2 microns to 2,000 microns. In an embodiment, the thickness may be in a range from approximately 10 microns to 100 microns. In another embodiment, the thickness may be in a range from approximately 20 microns to 80 microns.

Prior to adhering CLS 8 to metal substrate 4, the surface of metallic layer 7 to be adhered to metal substrate 4 and/or the surface of metal substrate 4 may be surfaced treated. Surface treatment may be performed by any known process in the art to treat a metallic surface. In an embodiment, surface treatment may be performed by a peening process. Typical peening processes involve the impacting a surface with numerous, small particles. An example of a peening process is shot peening. The shot-peened, roughened surface may have a characteristic roughness identifiable by the appearance of small craters in the surface. In another embodiment, surface treatment may include sandblasting the surface of metallic layer 7 to be adhered to metal substrate 4 and/or sandblasting the surface of metal substrate 4. In another embodiment, surface treatment may include chemical etching of the surface of metallic layer 7 to be adhered to metal substrate 4 and/or chemical etching the surface of metal substrate 4. In another embodiment, surface treatment may include belt sanding of the surface of metallic layer 7 to be adhered to metal substrate 4 and/or belt sanding the surface of metal substrate 4.

The aforementioned surface treatments may be performed used in combination to treat the surface of metallic layer 7 and/or the surface of metal substrate 4. For example, the surface of metallic layer 7 to be adhered to metal substrate 4 may be first shot-peened and then the shot-peened surface may be treated by sandblasting prior to adhesion to metal substrate 4.

During normal use, the wear resistant article 2 disclosed herein may typically come in sustained contact and movement, through resin embedded fabric 6 of composite lubricating sheet 8, with another object(s) under a high pressure load and under vibratory, reciprocating, and/or circular motions via. The high pressure load may be in a range from approximately 100 MPa to approximately 600 MPa. Wear resistant article 2 in sustained contact with another object may have a Coefficient of Friction (COF) value in a range from 0.01 to 0.1. In an embodiment, the COF value may be less than approximately 0.05. In another embodiment, the COF value may be less than 0.04.

The utility of wear resistant article 2 may be demonstrated by measuring the durability of CLS 8 under controlled pressure and wear conditions. Wear under pressure may be demonstrated, for example, by: providing a body having a surface subject to wear, such as a titanium block with a known roughness; adhering to the surface subject to wear composite lubricating sheet 8 wherein the adhering occurs between the metallic layer 7 and the titanium surface subject to wear; providing an object having a wear surface such as another titanium block; aligning resin embedded fabric 6 of CLS 8 with the wear surface of the other object with a pressure in a range from approximately 210 MPa to approximately 500 MPa; and causing resin embedded fabric 6 of CLS 8 to be in sustained contact with the surface of the other object.

### EXAMPLES

The present disclosure may be further defined by the following examples. It should be understood that the following examples, while indicating embodiments of the present disclosure, are given by way of illustration only. From the above discussion and the following examples, one having ordinary skill in the art can ascertain the essential characteristics of the present disclosure, and without departing from the spirit and scope thereof, may make various changes and modifications of the present disclosure to adapt it to various uses and conditions.

Table 1 lists Vickers Hardness values (HV) for metallic layer 7 of composite lubricating sheet (CLS) 8. Values listed in Table 1 are for metallic layer 7 in the form of a metallic foil. Vickers Hardness values are described in ASTM E-384 which is incorporated herein by reference in its entirety. Unless otherwise specified, HV in Table 1. means HV 0.1/20 as determined with 100 gram force applied for 20 seconds.

TABLE 1

| Designation | Foil-1 | Foil-2 | Foil-3 | Foil-4 | Foil 5 | Foil-6 |
|---|---|---|---|---|---|---|
| Material | Fe | Ti | Ti | Ti | Al | Al |
| Foil | Stainless | ASTM | ASTM | | | |
| Descrip- | Steel, | B265, | B265, | | | |
| tion | Type 304 | Grade = | Grade = | | | |
| | | 4 | 9 | | | |
| Thickness | 75 | 70 | 90 | 460 | 125 | 125 |
| (microns) | | | | | | |
| Meltallic | | | | | | |
| layer | | | | | | |
| Hardness, | 407 | 252 | 224 | 176 | 39.1 | 23* |
| HV 0.1/20 | | | | | | |
| HV Std Dev | 13 | 10 | 2.5 | 6.4 | 0.3 | 0.8 |

*Foil-6 Hardness HV is determined with 50 g for 20 seconds (HV 0.05/20)

CLS 8 of the present disclosure may be resistant to crushing by compressive forces. In one embodiment, a suitable test for resistance to compressible forces is to determine the fraction of compression that a strong compressive force produces. Table 2 lists Compression Fraction percentage values for CLS 8 having various metallic layers 7 and an entry (10) for CLS 8 without a metallic layer for comparison.

TABLE 2

| CLS | 1 | 2 | 3 | 4 | 5 | 6 | C1 |
|---|---|---|---|---|---|---|---|
| Metallic | Fe | Ti | Ti | Ti | Al | Al | None |
| Layer | | | | | | | |
| Thickness, | 370 | 370 | 400 | 800 | 460 | 435 | 280 |
| microns | | | | | | | |
| Compression | 2.6 | 1.6 | 2.8 | 1.42 | 5.83 | 6.55 | 8.63 |
| Fraction, % | | | | | | | |

In Table 2, CLS test samples 2, 3, and 4 are representative samples of Vespel ASB-0670 product grade available from E.I. du Pont de Nemours and Company in which the metallic layer is titanium. CLS test samples 1, 5, and 6 are representative samples of other Vespel® composite lubricating sheet 8 product grades in which the metallic layer 7 is steel (Fe) and aluminum. CLS test sample C1 is a comparative sample in which it does not have a metallic layer 7.

Compression fraction percentage values of CLSs 8 were determined using a Mitutoyo IP 54 micrometer and an Instron 1332 fatigue system with n 8800 controller. The Mitutoyo IP 54 micrometer was used to measure thickness of CLS by first measuring the initial thickness of a CLS square of approximately 25 mm by approximately 25 mm. The Instron 1332 fatigue system was used to apply compressive loads to the CLS square. The measured CLS square was then compressed with a 10 mm by 10 mm shot-peened surfaced Ti block to 450 MPa applied at 0.05 inch/min (1270 microns/min) using the Instron 1332 fatigue system. When 450 MPa pressure was achieved, the pressure was released and measurement of the final thickness of the CLS square was made within one minute using the Mitutoyo IP 54 micrometer.

CLS 8 of the present disclosure may be resistant to crushing by compressive forces and wear through rubbing/frictional forces. In one embodiment, a suitable test for resistance to compressible forces and simultaneous frictional force is to determine the Minimum Strokes number CLS 8 may sustain before succumbing to failure. Table 3 lists Minimum Strokes values for CLS 8 having a titanium metallic layer 7 and for CLS 8 without a metallic layer for comparison.

TABLE 3

| CLS | 1* | 2* | 3 |
|---|---|---|---|
| Metallic Layer | Ti | Ti | None |
| Pressure, MPa | 400 | 400 | 400 |
| Minimum Strokes | 43,527 | 44,244 | 362 |

*Two sets of test specimens used.

In Table 3, CLS test samples 1 and 2 are representative samples of Vespel ASB-0670 product grade available from E.I. du Pont de Nemours and Company in which the metallic layer is titanium. CLS test sample C1 is a comparative sample in which it does not have a metallic layer 7.

Minimum Strokes values of CLSs 8 in use with a metal substrate were determined using an Instron 1321 fatigue system with an 8800 controller. The Minimum Strokes values were reported as the number of reciprocating test strokes of 1.2 mm in length applied at 10 Hz accomplished by the relative motion of the article with respect to resin embedded fabric layer 6 of CLS 8.

Prior to evaluating wear under pressure, the resin embedded fabric layer 6 of CLS 8 was lightly coated with a lubricant containing a fluorochemical by spraying or painting the lubricant on the surface of the resin embedded fabric layer 6. The spraying or coating provides a thin translucent to an opaque coating of lubricant.

CLS 8 was adhered to a stationary metal substrate by an epoxy adhesive such as for example, NB 101 available from Newport Adhesives and Composites, Inc; Irvine, Calif. The stationary metal substrate was a sandblasted, 20 mm by 20 mm titanium block with a peen-hardened surface having a Rockwell C33 hardness. The metallic layer of CLS 8 was adhered to the titanium block with resin embedded fabric layer 6 of CLS 8 facing away from the titanium block. The adhesive was oven cured under low pressure (approximately 5 psi) comprising a first heating step to approximately 79° C. for 90 min and then a second heating step to approximately 149° C. for an hour. The titanium block was then mounted in the lower carrier of the Instron 1321 with CLS 8 facing up.

A second titanium block with a peen-hardened surface (Rc of 33) measuring approximately 10 mm by 10 mm was mounted in an upper carrier of the Instron 1321 and brought into parallel reversible contact with CLS 8 aligned in the center of the titanium block in the lower carrier. The pressure between the blocks was raised to 400 MPa, and reciprocating strokes were applied at a rate of 10 forward and 10 backward strokes per second with a stroke length of 1.2 mm. Testing was run until the onset of failure, i.e., a corner of the 10 mm by 10 mm titanium block penetrated resin embedded fabric layer 6 of CLS 8. The Minimum Strokes value represents the number of strokes to reach test specimen failure. The larger the Minimum Strokes value, the better the performance of CLS 8.

Comparing CLS examples 1 and 2 having a titanium metallic layer to example 3 not having a metallic layer, an approximate 100 fold improvement in test samples 1 and 2 was achieved. Under test conditions, a value greater than 10,000 Minimum Strokes represents durability to last through, for example, an engine maintenance cycle.

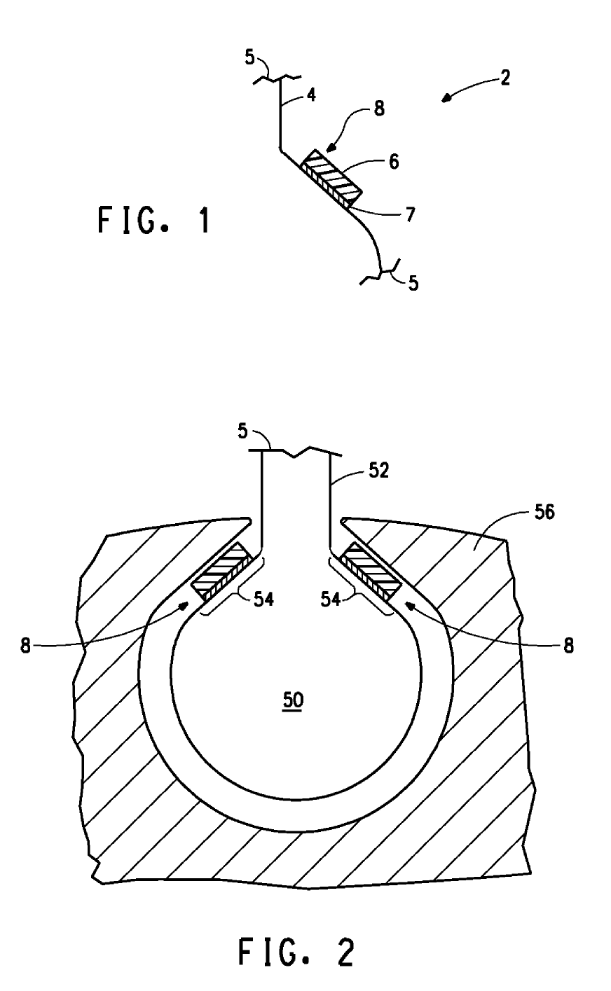

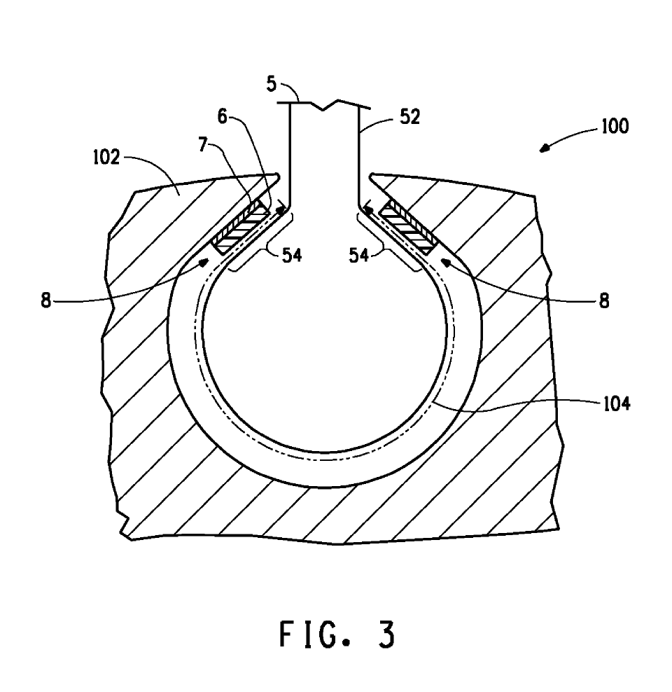

Another embodiment of a wear resistant article is shown in FIG. 2, in accordance with the present invention. Referring to FIG. 2, a wear resistant article 50 is shown having a turbine fan blade 52 and a composite lubricating sheets 8 adhered thereon. Turbine fan blade 52 may be an integrated component in a turbine engine. In an embodiment, turbine fan blade 52 may comprise a metal selected from titanium, aluminum, and steel. In another embodiment, turbine fan blade 52 may comprise titanium.

Embodiments of composite lubricating sheet 8 have been previously described and are herein incorporated by reference in their entirety. Composite lubricating sheet 8 may be adhered to fan blade roots 54 of turbine fan blade 52. Composite lubricating sheet 8 may protect fan blade roots 54 from deterioration when wear resistant article 50 is in use with, for example, a rotor disk 56. The forces and loads experienced between fan blade roots 54 and rotor disk 56 during operation of a turbine engine are known in the art. Performance characteristics of composite lubricating sheet 8 have been previously described and are herein incorporated by reference in their entirety. In another embodiment, composite lubricating sheet 8 may be adhered to a metal substrate such as a shim, metallic layer, or any other part already adhered to fan blade roots 54. The shim, metallic layer, etc. may comprise a metal selected from titanium or steel.

Another embodiment of a wear resistant article is shown in FIG. 3, in accordance with the present invention. Referring to FIG. 3, a wear resistant article 100 is shown having a rotor disk 102 and a composite lubricating sheets 8 adhered thereon. Rotor disk 102 may be an integrated component in a turbine engine. In an embodiment, rotor disk 102 may comprise a metal selected from titanium, aluminum, and steel. In another embodiment, rotor disk 102 may comprise titanium.

Embodiments of composite lubricating sheet 8 have been previously described and are herein incorporated by reference in their entirety. Composite lubricating sheet 8 may be adhered to an area of recess 104 of rotor disk 102. Composite lubricating sheet 8 may protect rotor disk 102 and/or fan blade roots 54 from deterioration when wear resistant article 100 is in use with fan blade 52. The forces and loads experienced between fan blade roots 54 and rotor disk 102 during operation of a turbine engine are known in the art. Performance characteristics of composite lubricating sheet 8 have been previously described and are herein incorporated by reference in their entirety.

An embodiment of a turbine engine is described, in accordance with the present invention. The turbine engine may include at least one part having a composite lubricated sheet adhered thereon. The at least one part may include but is not limited to a turbine fan blade, a rotor disk, and a rotor disk assembly. Embodiments and performance characteristics of the composite lubricating sheet have been previously described and are herein incorporated by reference in their entirety. Embodiments of the turbine fan blade and rotor disk having a composite lubricating sheet adhered therein have been previously described.

The terms “first”, “second”, and the like, herein do not denote any order, quantity, or importance, but rather are used to distinguish one element from another, and the terms “a” and “an” herein do not denote a limitation of quantity, but rather denotes the presence of at least one of the referenced items. The modifier “about” used in connection with a quantity is inclusive of the state value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “to approximately 25 wt %, or, more specifically, approximately 5 wt % to approximately 20 wt %”, is inclusive of the endpoints and all intermediate values of ranges of “approximately 5 wt % to approximately 25 wt %”, etc.)

While various embodiments are described herein, it will be appreciated from the specification that various embodiments of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A wear resistant article comprising:
a composite lubricating sheet adhered to a metal substrate, wherein the composite lubricating sheet comprises:
a fabric at least partially embedded with a resin, the fabric including an aromatic polyamide yarn, and a mixed yarn having the aromatic polyamide yarn and a low-friction yarn; and
a metallic layer adhered to one side of the fabric.

2. The article according to claim 1, wherein the metal substrate comprises a part selected from the group consisting of a rotor disk and a turbine fan blade.

3. The article according to claim 1, wherein the metal substrate is an integrated component of a turbine engine.

4. The article according to claim 1, wherein the metal substrate comprises a metal selected from the group consisting of titanium, aluminum, steel, nickel, and alloys thereof.

5. The article according to claim 4, wherein the metal substrate is titanium.

6. The article according to claim 1, wherein the resin is phenol-formaldehyde resin.

7. The article according to claim 1, wherein the aromatic polyamide yarn is selected from the group consisting of poly(para-phenylene terephthalamide), poly(meta-phenylene terephthalamide), poly(meta-phenylene isophthalamide), poly(para-phenylene isophthalamide), combinations thereof, and copolymers thereof.

8. The article according to claim 1, wherein the low-friction yarn comprises graphite fiber or a fluoropolymer fiber.

9. The article according to claim 8, wherein the fluoropolymer fiber comprises a polytetrafluoroethylene.

10. The article according to claim 1, wherein the metallic layer is a metal selected from the group consisting of titanium, aluminum, steel, and nickel.

11. The article according to claim 10, wherein the metallic layer is titanium.

12. The article according to claim 1, wherein the metallic layer has a thickness in a range from approximately 50 microns to approximately 250 microns.

13. The article according to claim 1, wherein the metallic layer has a Vickers Hardness of approximately 30 HV or greater at a load of approximately 100 grams applied for approximately 20 seconds according to ASTM E-384.

14. The article according to claim 1, wherein the composite lubricating sheet has a Compression Fraction in a range of 0.1% to approximately 20% with a pressure applied by compressing at approximately 127 microns/minute up to approximately 450 MPa and then released.

15. The article according to claim 1, wherein the composite lubricating sheet additionally comprises an attaching layer between the fabric and the metallic layer, attaching layer comprising an adhesive selected from the group consisting of a thermoplastic adhesive or a thermoset adhesive.

16. A turbine engine including at least one part having a composite lubricating sheet adhered thereon, wherein the composite lubricating sheet comprises:
a fabric at least partially embedded by a resin, the fabric including an aromatic polyamide yarn and a mixed yarn having the aromatic polyamide yarn and a low-friction yarn; and
a metallic layer adhered to one side of the resin embedded fabric.

17. The engine according to claim 16, wherein the aromatic polyamide yarn is selected from the group consisting of poly(para-phenylene terephthalamide), poly(meta-phenylene terephthalamide), poly(meta-phenylene isophthalamide), poly(para-phenylene isophthalamide), combinations thereof, and copolymers thereof; and the low-friction yarn comprises graphite or a fluoropolymer.

18. The engine according to claim 16, wherein the metallic layer is a metal selected from the group consisting of titanium, aluminum, steel, and nickel.

19. The engine according to claim 16, wherein the metallic layer has a Vickers Hardness of approximately 30 HV or greater at a load of approximately 100 grams applied for approximately 20 seconds according to ASTM E-384.

20. The engine according to claim 16, wherein the composite lubricating sheet has a Compression Fraction in a range of 0.1% to approximately 20% with a pressure applied by compressing at approximately 127 microns/minute up to approximately 450 MPa and then released.
